(19) United States
(12) Patent Application Publication
(10) Pub. No.: US 2012/0120352 A1
(43) Pub. Date: May 17, 2012

(54) LIQUID CRYSTAL DISPLAY DEVICE

(75) Inventors: Tomoo Furukawa, Osaka (JP); Kazuyoshi Fujioka, Osaka (JP)

(73) Assignee: SHARP KABUSHIKI KAISHA, Osaka (JP)

(21) Appl. No.: 13/383,556

(22) PCT Filed: Jul. 6, 2010
(86) PCT No.: PCT/JP2010/061444

§ 371 Date: Jan. 11, 2012

(30) Foreign Application Priority Data
Jul. 22, 2009 (JP) 2009-171632

(51) Int. Cl. G02F 1/1335

(52) U.S. Cl. 349/106

(57) ABSTRACT

Provided is an MVA type liquid crystal display device (100) including a blue pixel (50B), a green pixel (50G), a red pixel (50R), a first linear alignment control structure (42), and a second linear alignment control structure (44). The first linear alignment control structure (42) has first straight line components extending in a first direction and second straight line components extending in a second direction that is different from the first direction in each of the blue pixel (50B), the green pixel (50G), and the red pixel (50R) independently. The second linear alignment control structure (44) has third straight line components extending in the first direction and fourth straight line components extending in the second direction in each of the blue pixel (50B), the green pixel (50G), and the red pixel (50R) independently. The azimuth angles of the first direction and the azimuth angles of the second direction in the blue pixel (50B), the green pixel (50G), and the red pixel (50R) satisfy a prescribed relation. The liquid crystal display device of the present invention provides an excellent color balance as viewed from the front.

### TECHNICAL FIELD

The present invention relates to a liquid crystal display (LCD) device. More particularly, the present invention relates to a VA (Vertical Alignment) type LCD.

### BACKGROUND ART

In recent years, as the display methods for liquid crystal display devices, wide viewing angle modes such as the MVA (Multi-domain Vertical Alignment) mode and IPS (In-Plain Switching) mode have been proposed and are employed in a wide variety of applications such as TVs (televisions) (Patent Document 1). Among them, MVA type liquid crystal display devices feature a high contrast ratio, and are in wide use. Referring to MVA type liquid crystal display devices, the directions into which liquid crystal molecules tilt due to the magnetic field is controlled by alignment control structures extending linearly (in bands or in strips) (hereinafter referred to as “linear alignment control structure”). Linear alignment control structure may be slits (openings) formed in an electrode or dielectric protrusions (ribs) formed on the electrode on the side facing the liquid crystal layer. The entire contents disclosed in Patent Document 1 are hereby incorporated herein by reference.

Also, for a liquid crystal display device, in order to display color images, color filters of, for example, red, green, and blue, which are three primary colors of light, are provided in each pixel. Color display is conducted by individually controlling the luminance of the red, green, and blue pixels. In recent years, multi primary color display devices that use other colors in addition to red, green, and blue are becoming widely used in the quest of liquid crystal display devices with wider color reproduction range. “Pixel” herein refers to the smallest display unit of the liquid crystal display device. In the case of color displays, “a pixel” refers to the smallest display unit of each primary color (typically, red, green or blue), and is also called “a dot.”

The refractive index anisotropy (birefringence magnitude) Δn of the liquid crystal material depends on the wavelength of light. In the case of the liquid crystal display device, therefore, even if the retardation, which is the product of Δn and the thickness d of the liquid crystal layer, is adjusted to maximize the transmittance of green light, which is the most recognizable color for human eyes, the transmittance of blue light and red light is not maximized.

Also, the birefringence magnitude (Δn) of the nematic liquid crystal material, which is a liquid crystal material currently in wide use for MVA type liquid crystal display devices, decreases in the order of blue (B), green (G), and red (R). That is, birefringence magnitudes for respective colors ΔnB, ΔnG, and ΔnR satisfy the relation of ΔnB>ΔnG>ΔnR. The MVA type liquid crystal display device is configured such that the transmittance increases as the retardation of the liquid crystal layer increases. Consequently, through the adjustment of the gradation characteristics (gradation-relative transmittance characteristics) using green, the most recognizable color, as the reference so that γ=2.2, for example, is achieved, the relative transmittance of blue pixels becomes the greatest in halftones, which is followed by the green pixels and red pixels in this order. As a result, the MVA type liquid crystal display device tends to provide bluish color displays in halftones.

As a way to solve this problem, the retardation may be adjusted to be uniform across pixels of different colors by increasing the thickness of the liquid crystal layer for pixels of blue, green, and red in this order (see Patent Document 2, for example). Such a configuration in which the thickness of the liquid crystal layer for pixels is adjusted for respective colors is sometimes called a multi-gap method.

A problem with the multi-gap method is that the response time becomes inconsistent among pixels of different colors. It is known that the response time (which is proportional to the inverse of the response speed) of the MVA type liquid crystal display device is approximately proportional to the square of the thickness of the liquid crystal layer. That is, the response time τ of the pixel having a thick liquid crystal layer is long (response speed is slow). When the thicknesses of the liquid crystal layer for the blue pixel, green pixel, and red pixel are d_{B}, d_{G}, and d_{R}, respectively, and the relation of d_{B}>d_{G}>d_{R} is satisfied, τ_{B}>τ_{G}>τ_{R} is also satisfied, where τ_{B}, τ_{G}, and τ_{R} are the response time of the blue pixel, green pixel, and red pixel, respectively.

Also, Patent Document 3 discloses a liquid crystal display device, where, in order to improve the color balance as viewed from an oblique angle of the MVA type liquid crystal display device having pixels of four or more colors, straight line-shaped alignment control structure elements (dielectric protrusions formed on an electrode or openings formed in an electrode, for example) are arranged in pixels of at least three prescribed colors such that their extending directions are mutually different among the colors. In the embodiment of the liquid crystal display device there, a relation of θ_{B}>θ_{G}>θ_{R} is satisfied, where θ is the azimuth angle of the straight line-shaped alignment control structure (the azimuth angle of the horizontal direction (rightward) of the display surface is 0° and the counterclockwise rotation is positive), and θ_{B}, θ_{G}, and θ_{R} are the azimuth angles of the straight line-shaped alignment control structure elements in the blue pixel, green pixel, and red pixel, respectively.

### RELATED ART DOCUMENTS

### Patent Documents

Patent Document 1: Japanese Patent Application Laid-Open Publication No. H11-242225 (U.S. Pat. No. 6,724,452)

Patent Document 2: Japanese Patent No. 3211853

Patent Document 3: Japanese Patent Application Laid-Open Publication No. 2007-219346

### SUMMARY OF THE INVENTION

### Problems to be Solved by the Invention

However, according to the studies conducted by the inventors of the present invention, the color balance as viewed from the front cannot be improved by employing the configuration disclosed in Patent Document 3.

The present invention was devised to solve the problem described above, and is aiming at improving the color balance as viewed from the front of MVA type liquid crystal display devices having red, green, and blue pixels.

### Means for Solving the Problems

A liquid crystal display device of the present invention includes: a first substrate having a plurality of electrodes; a second substrate having an opposite electrode; a vertical alignment type liquid crystal layer interposed between the first substrate and the second substrate; a plurality of color filters including blue, green, and red color filters disposed for the respective plurality of pixel electrodes; and blue pixels, green pixels, and red pixels. The first substrate has a first linear alignment control structure provided on the side facing the liquid crystal layer, and the second substrate has a second linear alignment control structure provided on the side facing the liquid crystal layer. The first linear alignment control structure includes first straight line components extending in a first direction and second straight line components extending in a second direction different from the first direction in each of the blue pixels, the green pixels, and the red pixel independently. The second linear alignment control structure includes third straight line components extending in the first direction and fourth straight line components extending in the second direction in each of the blue pixels, the green pixels, and the red pixels independently. In each of the blue pixels, the green pixels, and the red pixels, at least either the first and second straight line components or the third and fourth straight line components are present in plurality, and the first straight line component and the third straight line component are arranged alternately, and the second straight line component and the fourth straight line component are arranged alternately when viewed from a direction normal to the first substrate. When a voltage is applied on the liquid crystal layer for a given pixel, liquid crystal molecules present between the first straight line components and the third straight line components and between the second straight line components and the fourth straight line components fall into four different directions, forming four domains. When the azimuth angle of the horizontal direction of a display surface is 0° and a relation of 0°<θ_{B}, θ_{G}, and θ_{R}<90° is satisfied, where θ_{B} is the azimuth angle of the first direction in the blue pixel, θ_{G} is the azimuth angle of the first direction in the green pixel, and θ_{R} is the azimuth angle of the first direction in the red pixel, the azimuth angle of the second direction in the blue pixel is approximately equal to −θ_{B}, the azimuth angle of the second direction in the green pixel is approximately equal to −θ_{G}, and the azimuth angle of the second direction in the red pixel is approximately equal to −θ_{R}, and a relation of |θ_{B}−45.0°|>|θ_{G}−45.0°|>|θ_{R}−45.0°| is satisfied. The azimuth angles θ_{B}, θ_{G}, θ_{R} are determined counterclockwise or clockwise from the horizontal direction to satisfy 0°<θ_{B}, θ_{G}, and θ_{R}<90°.

In an embodiment, the first linear alignment control structure is composed of openings (slits) formed in the plurality of pixel electrodes.

In an embodiment, the second linear alignment control structure is composed of dielectric protrusions (ribs) formed on the opposite electrode on the side facing the liquid crystal layer.

In an embodiment, the thickness of the liquid crystal layer for the blue pixels, green pixels, and red pixels is substantially the same. Specifically, the difference between the maximum thickness and the minimum thickness of the liquid crystal layer is preferably no more than 0.2 μm, and more preferably no more than 0.1 μm.

### Effects of the Invention

According to the present invention, the color balance as viewed from the front of an MVA type liquid crystal display device having red, green, and blue pixels can be improved.

### BRIEF DESCRIPTION OF THE DRAWINGS

FIG. 1(a) is a plan view schematically showing the arrangement of the linear alignment control structure elements in three pixels (a red pixel, a green pixel, and a blue pixel) of a liquid crystal display device 100A according to an embodiment of the present invention. FIG. 1(b) is a plan view schematically showing the arrangement of the linear alignment control structure elements in three pixels (a red pixel, a green pixel, and a blue pixel) of a liquid crystal display device 100B according to an embodiment of the present invention.

FIG. 2 is a schematic cross-sectional view taken along the line I-I′ of FIG. 1(a) of the liquid crystal display device 100A.

FIG. 3 is a plan view showing the direction of the directors of four liquid crystal domains A, B, C, and D formed within a pixel of an MVA type liquid crystal display device.

FIG. 4 is a graph showing the wavelength dispersion of the birefringence magnitude (Δn) of a liquid crystal material for the MVA type liquid crystal display device.

FIG. 5 is a graph showing the y characteristics of R, G, and B of the liquid crystal display device of a comparison example.

FIG. 6(a) and FIG. 6(b) are graphs showing γ characteristics of R, G, and B of the liquid crystal display devices 100A and 100B.

### DETAILED DESCRIPTION OF EMBODIMENTS

Below, MVA type liquid crystal display devices according to embodiments of the present invention are described with reference to figures. The present invention, however, is not limited to the embodiments described herein, which are shown as examples.

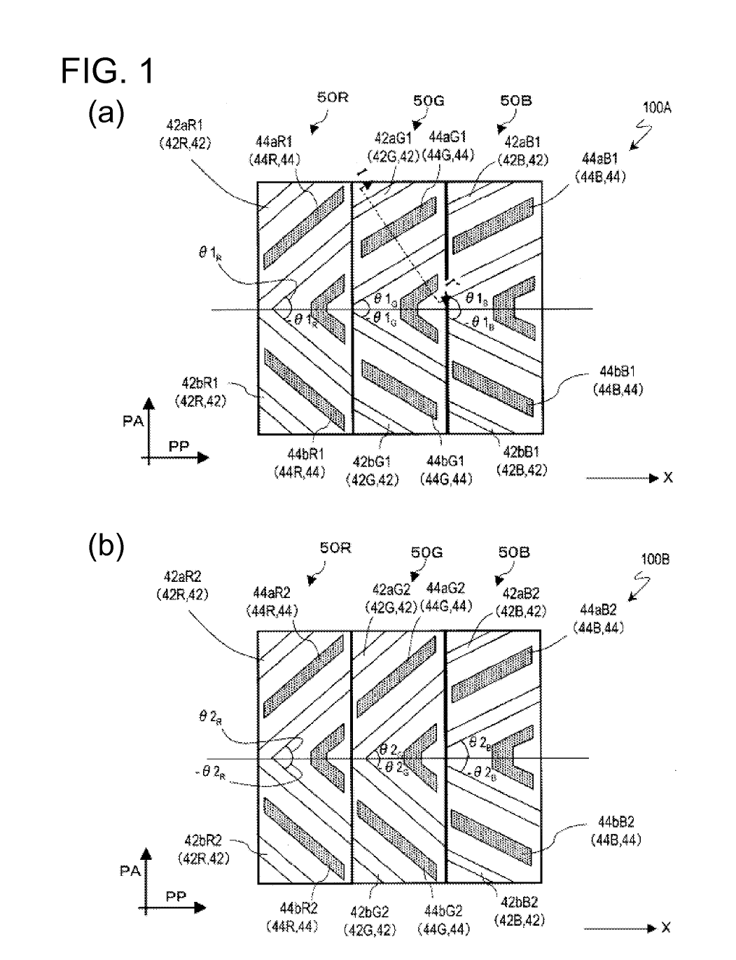

First, configurations of MVA type liquid crystal display devices 100A and 100B are described with reference to FIG. 1 to FIG. 3.

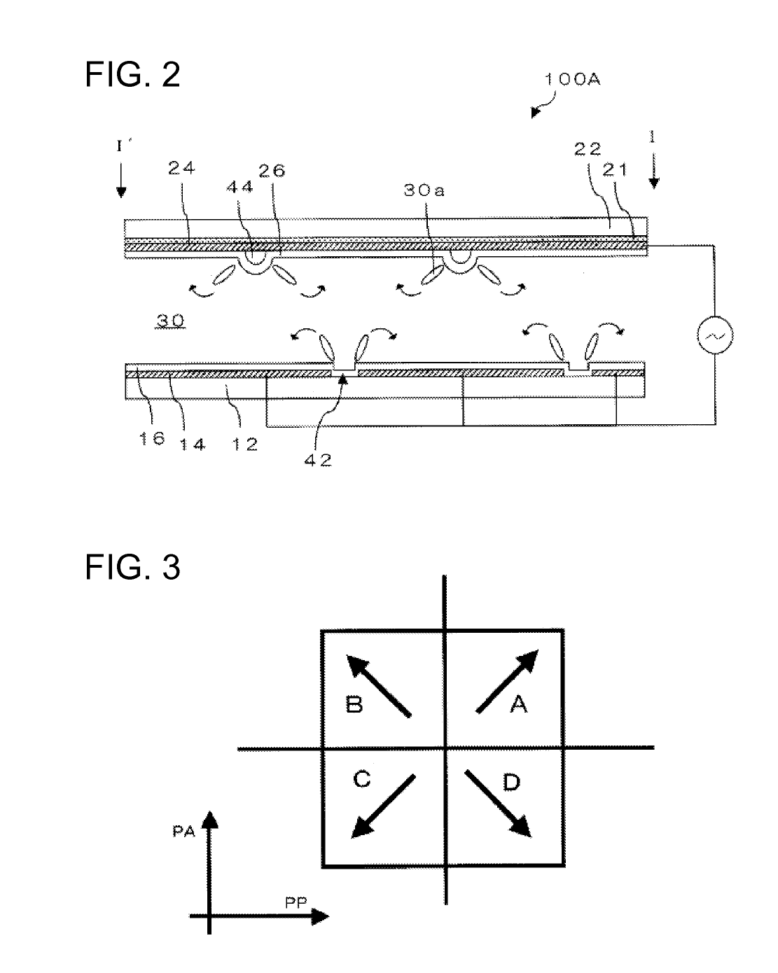

FIG. 1(a) and FIG. (b) schematically shows the arrangement of the linear alignment control structure elements in three pixels (a red pixel, green pixel, and a blue pixel) of liquid crystal display devices 100A and 100B according to embodiments of the present invention. FIG. 2 schematically shows a cross-sectional view of the liquid crystal display device 100A. Because the cross-sectional structure of the liquid crystal display device 100B is substantially the same as the cross-sectional structure of the liquid crystal display device 100A, illustration of the cross-sectional structure of the liquid crystal display device 100B is omitted. FIG. 1(a) and FIG. (b) only show the portion of pixels that transmits the light contributing to the display, and do not include light-shielding portion such as TFTs, gate bus lines, source bus lines, and the black matrix (light-shielding layer).

FIG. 1(a) is a plan view schematically showing the arrangement of the linear alignment control structure elements in three pixels of a red pixel 50R, a green pixel 50G, and a blue pixel 50B, of a liquid crystal display device 100A of the present invention. The liquid crystal display device 100A has a plurality of pixels arranged in a matrix of rows and columns, where three pixels, i.e., the red pixel 50R, the green pixel 50G, and the blue pixel 50B arranged adjacent to each other in the row direction are combined into one unit to constitute the smallest unit of a color image (hereinafter referred to as “color display pixel”).

The liquid crystal display device 100A has a first linear alignment control structure 42 provided on the first substrate on the side facing the liquid crystal layer, and a second linear alignment control structure 44 provided on the second substrate on the side facing the liquid crystal layer.

The first linear alignment control structures 42 (42B, 42G, and 42R) in respective pixels, i.e., the blue pixel 50B, the green pixel 50G, and the red pixel 50R, include first straight line components 42aR1, 42aG1, and 42aB1 extending in a first direction and disposed in each of the respective pixels independently, and second straight line components 42bR1, 42bG1, and 42bB1 extending in a second direction that is different from the first direction and disposed in each of the respective pixels independently. The second linear alignment control structures 44 (44B, 44G, and 44R) in respective pixels, i.e., the blue pixel 50B, the green pixel 50G, and the red pixel 50R, include third straight line components 44aR1, 44aG1, and 44aB1 extending in the first direction and disposed in each of the respective pixels independently, and fourth straight line components 44bR1, 44bG1, and 44bB1 extending in the second direction and disposed in each of the respective pixels independently.

In each of the blue pixel 50B, the green pixel 50G, and the red pixel 50R, at least either the first and the second straight line components of the first linear alignment control structures 42 (42B, 42G, and 42R) or the third and the fourth straight line components of the second linear alignment control structures 44 (44B, 44G, and 44R) are present in plurality, and the first straight line components and the third straight line components are arranged alternately, and the second straight line components and the fourth straight line components are arranged alternately when viewed from the normal direction to the first substrate. That is, the first straight line components and the third straight line components are disposed in parallel with each other with prescribed intervals between them, and the second straight line components and the fourth straight line components are disposed in parallel with each other with prescribed intervals between them. The interval between the first straight line component and the third straight line component, and the interval between the second straight line component and the fourth straight line component are the same.

Here, in the blue pixel 50B, there are two first straight line components 42aB1 and two second straight line components 42bB1 of the first linear alignment control structures 42B, and there are two third straight line components 44aB1 and two fourth straight line components 44bB1 of the second linear alignment control structures 44B. The first straight line components 42aB1 and the third straight line components 44aB1 are arranged alternately, and the second straight line components 42bB1 and the fourth straight line components 44bB1 are arranged alternately.

Likewise, in the green pixel 50G, there are two first straight line components 42aG1 and two second straight line components 42bG1 of the first linear alignment control structure 42G, and there are two third straight line components 44aG1 and two fourth straight line components 44bG1 of the second linear alignment control structure 44G. The first straight line components 42aG1 and the third straight line components 44aG1 are arranged alternately, and the second straight line components 42bG1 and the fourth straight line components 44bG1 are arranged alternately. Also, in the red pixel 50R, there are two first straight line components 42aR1 and two second straight line components 42bR1 of the first linear alignment control structure 42R, and there are two third straight line components 44aR1 and two fourth straight line components 44bR1 of the linear alignment control structure 44R. The first straight line components 42aR1 and the third straight line components 44aR1 are arranged alternately, and the second straight line components 42bR1 and the fourth straight line components 44bR1 are arranged alternately.

As shown in FIG. 2, each of the pixels of the liquid crystal display device 100A includes a pixel electrode 14 formed on a first substrate 12, an opposite electrode 24 formed on a second substrate 22 and facing the pixel electrode 14, and a vertical alignment type liquid crystal layer 30 interposed between the pixel electrode 14 and the opposite electrode 24. The vertical alignment liquid crystal layer 30 contains a nematic liquid crystal material having a negative dielectric anisotropy, whose liquid crystal molecules 30a are aligned approximately normal (at least 87° and no more than 90°, for example) to the surfaces of the pixel electrode 14 and the opposite electrode 24 when no voltage is applied. Typically, by providing vertical alignment films 16 and 26 on the pixel electrode 14 and the opposite electrode 24, respectively, on their surfaces facing the liquid crystal layer 30, liquid crystal molecules 30a aligned approximately normal to the pixel electrode 14 and the opposite electrode 24 are obtained. With linear dielectric protrusions (ribs) in place as the linear alignment control structure, liquid crystal molecules 30a near the dielectric protrusions on the side facing the liquid crystal layer 30 are aligned approximately normal to the surface of the linear dielectric protrusions.

In the liquid crystal display device 100A, each of the pixels are provided with a color by way of the color filter layer 21 formed on the second substrate 22. Colors are arranged in stripes, for example, but the color arrangement is not limited to such. Also, a color filter layer may be provided on the first substrate 12.

The liquid crystal display device 100A has linear openings 42 formed in the pixel electrode 14 as the first linear alignment control structure 42, and also has linear dielectric protrusions 44 formed on the opposite electrode 24 on the side facing the liquid crystal layer 30 as the second linear alignment control structure 44. The linear dielectric protrusions 44 are formed of a photosensitive resin, for example. The linear dielectric protrusions 44 align the liquid crystal molecules 30a approximately normal to their sides and thereby operating to align the liquid crystal molecules 30a vertically to the direction in which the linear dielectric protrusions 44 extend. The linear openings 42 creates oblique electromagnetic fields in the liquid crystal layer 30 near the edges of the linear openings 42 when there is a difference in potential between the pixel electrode 14 and opposite electrode 24 so that the liquid crystal molecules 30a are aligned vertically to the direction in which the linear openings 42 extend. The liquid crystal molecules 30a in a liquid crystal region defined between the linear openings 42 and the linear dielectric protrusions 44 fall (tilt) in the directions indicated with arrows in the figure under the alignment control force from the linear openings 42 and the linear dielectric protrusions 44 when a voltage is applied between the pixel electrode 14 and the opposite electrode 24. That is, because liquid crystal molecules 30a fall in a uniform direction in each of the liquid crystal regions, each liquid crystal region can be considered as a domain. In each of the liquid crystal domains, the direction in which liquid crystal molecules fall when a voltage is applied is called the direction of the director of the liquid crystal domain. Two liquid crystal domains having director directions that are different from each other by 180° are formed on the respective sides of the linear opening 42 and the linear dielectric protrusion 44, respectively.

In a typical conventional MVA type liquid crystal display device, four types of domains A, B, C and D as shown in FIG. 3 are formed for each pixel. “PP” in FIG. 3 denotes the polarization axis of the polarizing plate proximal to the back side (the backlight side), and “PA” denotes the polarization axis of the polarizing plate proximal to the viewer's side. As shown in FIG. 3, director directions of the four types of liquid crystal domains A, B, C, and D are four directions, where the difference between any two directions is approximately equal to an integral multiple of 90°. The directions also form angles of approximately 45° with the polarization axes (PP and PA) of the polarizing plates arranged in a crossed Nicols state. When the azimuth angle of the polarization axis PP is 0° and the counterclockwise rotation is positive, the director directions of the four liquid crystal domains A to D are approx. 45.0°, approx. 135.0°, approx. 225.0°, and approx. 315.0°, respectively. That is, conventionally, linear alignment control structure elements were disposed to extend in the direction that forms an angle of approx. 45° with the polarization axes PP and PA. In the case called “multi-pixel structure” or “pixel division structure” where one pixel is divided into two or more sub-pixels, different voltages are applied for each of the sub-pixels, and the luminance of a conventional pixel is displayed with the average luminance (gradation) of the plurality of sub-pixels, the entire pixel needs to include the four domains A, B, C, and D. Of course, the linear alignment control structures may be arranged so that four liquid crystal domains A to D are formed in each of the sub-pixels.

FIG. 1(a) is referenced again.

For the liquid crystal display device 100A, unlike the case of a conventional MVA type liquid crystal display device, the directions that the first linear alignment control structures 42 and the second linear alignment control structures 44 extend, i.e., the first and the second directions, are determined in each of the blue pixel 50B, the green pixel 50G, and the red pixel 50R independently.

Here, suppose the azimuth angle of the horizontal direction of the display surface (direction X in FIG. 1(a)) of the liquid crystal display device 100A is 0°. Direction X is the direction of row of pixels arranged in a matrix. Suppose the azimuth angle of the first direction in the blue pixel 50B is θ1_{B}, the azimuth angle of the first direction in the green pixel 50G is θ1_{G}, and the azimuth angle of the first direction in the red pixel 50R is θ1_{R}. When the counterclockwise rotation is positive, the relation of 0°<θ1_{B}, θ1_{G}, and θ1_{R}<90° is satisfied. In this case, the azimuth angle of the second direction in the blue pixel 50B is approximately equal to −θ1_{B}, the azimuth angle of the second direction in the green pixel 50G is approximately equal to −θ1_{G}, and the azimuth angle of the second direction in the red pixel 50R is approximately equal to −θ1_{R}. That is, the first direction and the second direction in each pixel are symmetrical with respect to the horizontal direction. Regarding the liquid crystal display device 100A, the first directions in the blue pixel 50B, in the green pixel 50G, and in the red pixel 50R satisfy the relation of |θ1_{B}−45.0°|>|θ1_{G}−45.0°|>|θ1_{R}−45.0°|.

That is, in contrast to the conventional MVA type liquid crystal display device where the first direction and the second direction are determined at approximately 45° from the horizontal direction in all pixels, in the liquid crystal display device 100A of this embodiment, the first and second directions in the blue pixel 50B, the green pixel 50G, and in the red pixel 50R are different from one another, and the deviation from 45° is the greatest in the blue 50B, the second greatest in the green pixel 50B, and the smallest in the red pixel 50R.

Here, in MVA type liquid crystal display devices, the relationship between the director direction of the liquid crystal domain and the transmitted light intensity is explained. As shown in FIG. 1(a), in the liquid crystal display device 100A, the two polarizing plates are arranged in a crossed Nicole state with the liquid crystal layer interposed between them. The polarization axis PP of the polarizing plate proximal to the back side (the backlight side) is arranged horizontally, and the polarization axis PA of the polarizing plate proximal to the viewer is arranged vertically. If the azimuth angle of direction X in FIG. 1 is 0°, and the counterclockwise rotation is positive, the angle formed between the liquid crystal domain director and the polarization direction is expressed as an azimuth angle θ_{L} (0°≦θ_{L}≦360°). The transmitted light intensity (as viewed from the front) I in the white display state is expressed in the Equation (1) below, where d is the thickness of the liquid crystal layer, Δn is the birefringence magnitude of the liquid crystal material, and λ is the wavelength of the incident light.

I∝((sin 2θ_{L})×(sin(πdΔn/λ)))² (1)

As understood from Equation (1), the transmitted light intensity I is maximized when θ_{L}=45.0°, 135.0°, 225.0°, and 315.0°. That is, the transmitted light intensity can be maximized by forming the liquid crystal domains A to D shown in FIG. 3. The azimuth angle of the first direction, which characterizes the positioning of the linear alignment control structures for formation of the liquid crystal domains A to D, is 45°. In a conventional MVA type liquid crystal display device (hereinafter may be referred to as “comparison example”), the azimuth angle of the first direction (corresponds to θ1_{B}, θ1_{G}, and θ1_{R} of FIG. 1(a)) was set to 45° regardless of the color of the pixel.

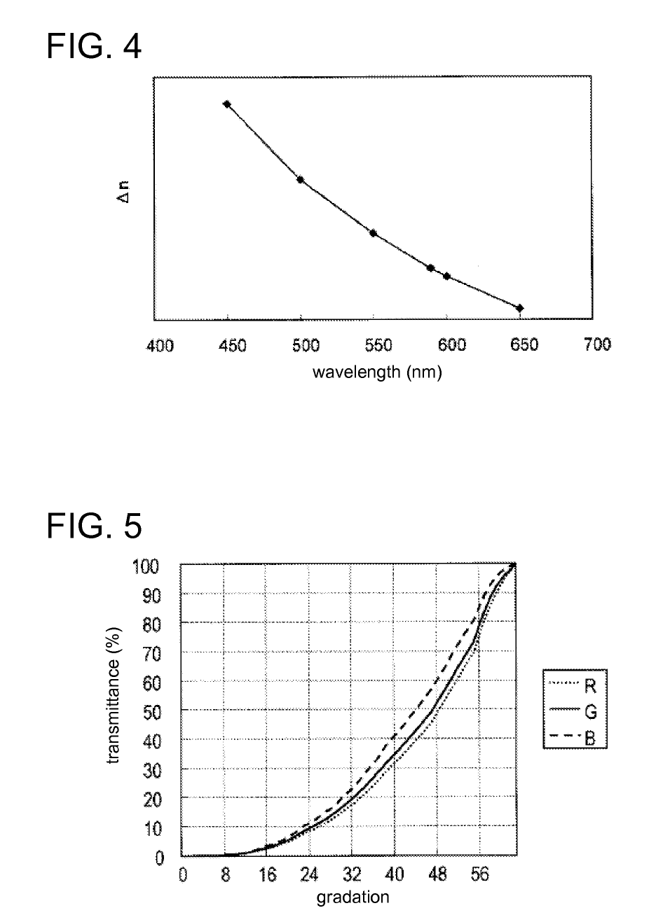

Here, a problem associated with the wavelength dispersion of the birefringence magnitude Δn described above arises. FIG. 4 shows the wavelength dependency of the birefringence magnitude (Δn) of a nematic liquid crystal material used in the MVA type liquid crystal display device.

As shown in FIG. 4, the relation of Δn_{B}>Δn_{G}>Δn_{R} is satisfied. Consequently, if the gradation characteristics (gradation—relative transmittance characteristics) is adjusted using green, the most recognizable color as a reference, so as to satisfy γ=2.2, for example, the relative transmittance in halftones (excluding black and white) is the greatest in the blue pixel, and is smaller in the green pixel and the red pixel in this order, as shown in FIG. 5. Thus, the conventional MVA type liquid crystal display device has a problem that the halftone images tend to become bluish.

When a liquid crystal material having the wavelength dispersion of the birefringence magnitude Δn shown in FIG. 4 is used, for the liquid crystal display device 100A, θ1_{B} is set to approx. 23.4°, θ1_{G} is set to approx. 38.3°, and θ1_{R} is set to approx. 45.0°, for example. That is, by shifting the four director directions θ_{L} of the liquid crystal domains in the green pixel and blue pixel, where the relative transmittance is higher than that of the red pixel, from approx. 45.0°, approx. 135.0°, approx. 225.0°, and approx. 315.0°, the transmittances of the green pixel and the blue pixel are reduced to make the relative transmittance of the red, green, and blue pixels equal. Specifically, the director directions θ_{L} of the liquid crystal domains in the red pixel are unchanged as approx. 45.0°, approx. 135.0°, approx. 225.0°, and approx. 315.0° (same as the liquid crystal domains A to D in FIG. 3); and the director directions θ_{L} of the liquid crystal domains in the green pixel are set to approx. 51.7°, approx. 128.3°, approx. 231.7°, and approx. 308.3°; and the director directions θ_{L} of the liquid crystal domains in the blue pixel are set to approx. 66.6°, approx. 113.4°, approx. 246.6°, and approx. 293.4°. The values of θ_{L} can be determined from Equation (1).

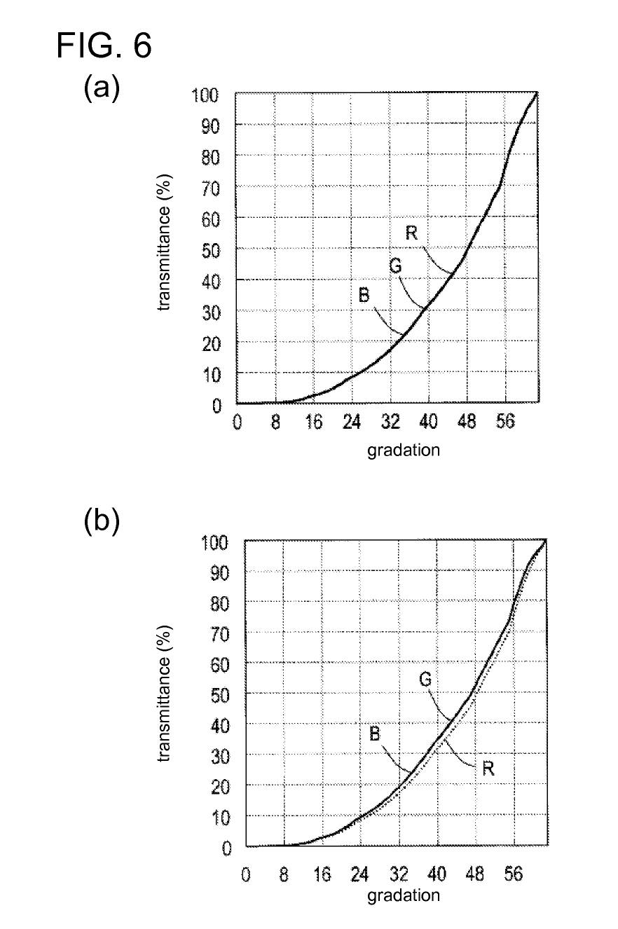

FIG. 6(a) shows the gradation characteristics of pixels of different colors of the liquid crystal display device 100A designed as described above. As understood from FIG. 6(a), the gradation characteristics (γ curves) of the blue pixel, the green pixel, and the red pixel of the liquid crystal display device 100A are identical. As a result, in the case of the liquid crystal display device 100A, the display does not become bluish in halftones, and an optimum color balance in the display as viewed from the front can be obtained. Of course, the absolute light intensity of each color is set in consideration of the wavelength dispersion in the intensity of the light emitted from the light source to achieve a desired white balance.

Although the linear alignment control structures 42 and 44 of the liquid crystal display device 100A shown in FIG. 1(a) are arranged in “<” shape, they may, of course, also be arranged in “>” shape symmetrical with respect to the vertical direction. In this case, the azimuth angles θ1_{B}, θ1_{G}, and θ1_{R} are determined so that the relation 0°<θ1_{B}, θ1_{G}, and θ1_{R}<90° is satisfied, where the clockwise rotation from the horizontal direction (leftward) is positive.

As described above, in the blue pixel 50B, green pixel 50G, and red pixel 50R of the liquid crystal display device 100A, the azimuth angles of the first direction satisfy the relation |θ1_{B}−45.0°|>|θ1_{G}−45.0°|>|θ1_{R}−45.0°|. Therefore, compared to the liquid crystal display device of the comparison example (where the azimuth angle of the first direction is set to 45° regardless of the pixel color), the color balance as viewed from the front is improved.

Next, a liquid crystal display device 100B shown in FIG. 1(b), which is another embodiment of the present invention, is described.

A liquid crystal display device 100B has, like the liquid crystal display device 100A, first linear alignment control structures 42 provided on the first substrate on the side facing the liquid crystal layer, and second linear alignment control structures 44 provided on the second substrate on the side facing the liquid crystal layer.

The first linear alignment control structures 42 (42B, 42G, and 42R) in respective pixels, i.e., the blue pixel 50B, green pixel 50G, and red pixel 50R, include first straight line components 42aR2, 42aG2, and 42aB2 extending in a first direction and disposed in each of the respective pixels independently, and second straight line components 42bR2, 42bG2, and 42bB2 extending in a second direction that is different from the first direction and disposed in each of the respective pixels independently. The second linear alignment control structures 44 (44B, 44G, and 44R) in the respective pixels, i.e., the blue pixel 50B, the green pixel 50G, and the red pixel 50R, include third straight line components 44aR2, 44aG2, and 44aB2 extending in the first direction and disposed in each of the respective pixels independently, and fourth straight line components 44bR2, 44bG2, and 44bB2 extending in the second direction and disposed in each of the respective pixels independently. The basic configurations of the first linear alignment control structures 42 and the second linear alignment control structures 44 are the same as those of the liquid crystal display device 100A, and therefore the description of them is omitted.

In the case of the liquid crystal display device 100A, the first directions of the blue pixel 50B, the green pixel 50G, and the red pixel 50R satisfy the relation of |θ1_{B}−45.0°|>|θ1_{G}−45.0°|>|θ1_{R}−45.0°|. That is, the color balance as viewed from the front is improved by reducing the relative transmittance of the blue pixel 50B and the green pixel 50G. As a result, the display luminance of the liquid crystal display device 100A (absolute transmittance in the white display state) is lower than that of the liquid crystal display device of the comparison example. For example, in the case of the liquid crystal display device 100A described above, where θ1_{B} is set to approx. 23.4°, θ1_{G} is set to approx. 38.3°, and θ1_{R} is set to approx. 45.0°, the display luminance is reduced by about 15% according to the calculation of Equation (1).

In comparison, in the case of the liquid crystal display device 100B, the transmittance of only the blue pixel 50B, where the transmitted light intensity is especially high, is reduced. Specifically, only the azimuth angle θ2_{B} of the first direction in the blue pixel 50B is shifted from 45°. That is, in the blue pixel 50B, green pixel 50G, and the red pixel 50R of the liquid crystal display device 100B, the azimuth angles of the first directions satisfy the relation |θ2_{B}−45.0°|>|θ2_{G}−45.0°|=|θ2_{R}−45.0°|=0. From the perspective of the display luminance, as shown in this example, θ2_{G}=θ2_{R}=45.0° is most preferable. However, as long as the relation |θ2_{B}−45.0°|>|θ2_{G}−45.0°|=|θ2_{R}−45.0°| is satisfied, the display luminance is improved than the case with the liquid crystal display device 100A, which satisfies the relation |θ1_{B}−45.0°|>|θ1_{G}−45.0°|>|θ1_{R}−45.0°|. In the case of the liquid crystal display device 100B, because the display luminance of green, the most recognizable color, can be made greater than in the case of the liquid crystal display device 100A, the effect of the improvement perceived by the viewer is more significant. Also, the problem that the display becomes bluish in halftones can be reduced.

When a liquid crystal material having a wavelength dispersion of the birefringence magnitude Δn shown in FIG. 4 is used, θ2_{B} of the liquid crystal display device 100B is set to approx. 24.3°, and θ2_{G} and θ2_{R} are set to approx. 45.0°, for example. That is, only for the blue pixel where the relative transmittance is the greatest, the four director directions θ_{L} of the liquid crystal domain are shifted from approx. 45.0°, approx. 135.0°, approx. 225.0°, and approx. 315.0° to reduce the transmittance in the blue pixel and to make the relative transmittance close to that of the red pixel and the green pixel. Specifically, the director directions θ_{L} in the red and green pixels are unchanged as approx. 45.0°, approx. 135.0°, approx. 225.0°, and approx. 315.0° (same as the liquid crystal domains A to D in FIG. 3), and the director directions θ_{L} of the liquid crystal domain in the blue pixel are set to approx. 65.7°, 114.3°, 245.7°, and 294.3°. The values of θ_{L} can be determined by Equation (1). With this configuration, the reduction in the display luminance of the liquid crystal display device 100B from that of the liquid crystal display device of the comparison example is suppressed to approx. 5.7%.

FIG. 6(b) shows the gradation characteristics of pixels of different colors of the liquid crystal display device 100B designed as described above. As understood from FIG. 6(b), the relative transmittance of the blue pixel of the liquid crystal display device 100B decreases and the gradation characteristics (γ curve) of the blue and green pixels are almost identical. As a result, in the case of the liquid crystal display device 100B, the problem that the display becomes bluish in halftones is suppressed.

As described above, in the blue pixel 50B, green pixel 50G, and red pixel 50R of the liquid crystal display device 100B, the azimuth angles of the first direction satisfy the relation of |θ2_{B}−45.0°|>|θ2_{G}−45.0°|=|θ2_{R}−45.0°|. Therefore, compared to the liquid crystal display device of the comparison example (where the azimuth angle of the first direction is set to 45° regardless of the pixel color), the color balance as viewed from the front is improved and a better display luminance than that of the liquid crystal display device 100A can be obtained.

Although in the example above, θ1_{B}, θ1_{G}, and θ2_{B} are set to under 45.0°. However, as can be understood from Equation (1), a similar effect can be obtained with θ1_{B}, θ1_{G}, and θ2_{B}>45.0°.

The liquid crystal display devices 100A and 100B are merely examples. Needless to say, θ1_{B}, θ1_{G}, θ2_{B}, θ2_{G} and the like may be set as appropriate depending on the Δnd of the liquid crystal layer.

Also, in the case of liquid crystal display devices 100A and 100B according to embodiments of the present invention, the thicknesses of the liquid crystal layer 30 for the blue pixel 50B, the green pixel 50G, and the red pixel 50R can be made approximately equal. Specifically, the difference between the greatest thickness of the liquid crystal layer and the smallest thickness of the liquid crystal layer is preferably no more than 0.2 μm, and more preferably no more than 0.1 μm. Consequently, the response speed problem with the conventional multi-gap structure does not occur. Further, the MVA type liquid crystal display device according to embodiments of the present invention has also an advantage that it can be manufactured only by changing the design of the mask for forming the linear alignment control structures, because its manufacturing process is the same as that of the conventional MVA type liquid crystal display device.

### INDUSTRIAL APPLICABILITY

The present invention is widely applicable to liquid crystal display devices generally used.

### DESCRIPTION OF REFERENCE CHARACTERS

12, 22 substrate

14 pixel electrode

24 opposite electrode

16, 26 vertical alignment film

21 color filter layer

30 liquid crystal layer

30a liquid crystal molecule

42, 42R, 42G, 42B linear opening (first linear alignment control structure)

44, 44R, 44G, 44B linear dielectric protrusions (second linear alignment control structure)

50R red pixel

50G green pixel

50B blue pixel

100A, 100B liquid crystal display device

1. An MVA type liquid crystal display device, comprising:
a first substrate having a plurality of pixel electrodes;
a second substrate having an opposite electrode;
a vertical alignment type liquid crystal layer interposed between said first substrate and said second substrate;
a plurality of color filters including blue, green, and red color filters disposed for respective said plurality of pixel electrodes; and
blue pixels, green pixels, and red pixels,
wherein said first substrate has a first linear alignment control structure provided on a side facing said liquid crystal layer,
wherein said second substrate has a second linear alignment control structure provided on a side facing said liquid crystal layer,
wherein said first linear alignment control structure includes first straight line components extending in a first direction and second straight line components extending in a second direction different from said first direction in each of said blue pixels, said green pixels, and said red pixels independently,
wherein said second linear alignment control structure includes third straight line components extending in said first direction and fourth straight line components extending in said second direction in each of said blue pixels, said green pixels, and said red pixels independently,
wherein in each of the blue pixels, the green pixels, and the red pixels, at least either said first and second straight line components or said third and fourth straight line components are present in plurality, and said first straight line components and said third straight line components are arranged alternately, and said second straight line components and said fourth straight line components are arranged alternately when viewed from a direction normal to said first substrate,
wherein when a voltage is applied on said liquid crystal layer for a given pixel, liquid crystal molecules present between said first straight line components and said third straight line components and between said second straight line components and said fourth straight line components fall into four different directions, forming four domains, and
wherein when an azimuth angle of a horizontal direction of a display surface is 0° and a relation of 0°<θ_{R}, θ_{G}, and θ_{R}<90° is satisfied, where θ_{R} is the azimuth angle of said first direction in said blue pixels, θ_{G} is the azimuth angle of said first direction in said green pixels, and θ_{R} is the azimuth angle of said first direction in said red pixels, the azimuth angle of said second direction in said blue pixels is approximately equal to −θ_{R}, the azimuth angle of said second direction in said green pixels is approximately equal to −θ_{G}, and the azimuth angle of said second direction in said red pixels is approximately equal to −θ_{R}, and a relation of |θ_{R}−45.0°|>θ_{G}−45.0°|≧|θ_{R}−45.0°| is satisfied.

2. The liquid crystal display device according to claim 1, wherein said first linear alignment control structure is composed of openings formed in said plurality of pixel electrodes.

3. The liquid crystal display device according to claim 1, wherein said second linear alignment control structure is composed of dielectric protrusions formed on said opposite electrode formed on a side facing said liquid crystal layer.

4. The liquid crystal display device according to claim 1, wherein the thickness of said liquid crystal layer for said blue pixel, said green pixel, and for said red pixel is substantially the same.
